(19) United States
(12) Patent Application Publication
(10) Pub. No.: US 2010/0194316 A1
(43) Pub. Date: Aug. 5, 2010

(54) Method and Device for Field-Oriented Regulation of a Polyphase Machine

(76) Inventor: Martin Eisenhardt, Renningen (DE)

Correspondence Address: KENYON & KENYON LLP, ONE BROADWAY, NEW YORK, NY, 10004, US

(21) Appl. No.: 12/083,397

(22) PCT Filed: Sep. 18, 2006
(86) PCT No.: PCT/EP2006/066432

§ 371 Date: Mar. 29, 2010

(30) Foreign Application Priority Data
Oct. 13, 2005 (DE) 102005049070.0

(51) Int. Cl. H02P 21/14

(52) U.S. Cl. 318/400.02

(57) ABSTRACT

A method and a device for field-oriented regulation of a polyphase machine. An actual torque of the polyphase machine is ascertained, the ascertained actual torque is compared with a setpoint torque, and in the event that torque differences occur, the setpoint values for the flow-forming current and the torque-forming current are modified to bring the actual torque into agreement with the setpoint torque. The actual torque is calculated with the aid of the power balance of the polyphase machine.

### BACKGROUND INFORMATION

The use of polyphase machines in electric drives for hybrid and electric machines is known. These are operated using a field-oriented regulation. This regulation principle is characterized in that the three sinusoidal phase currents I_{U}, I_{V} and I_{W} are converted into a direct-current system having two independently settable direct currents using a mathematical algorithm. These direct currents are flow-forming current I_{D} and torque-forming current I_{Q}. For torque M of the polyphase machine, the following relationship applies:

M=K·I_{D}·I_{Q} (1)

where the letter K stands for a machine constant.

A pair of setpoint values I_{D,setpoint} and I_{Q,setpoint} is formed from a setpoint torque Mₛₑₜₚₒᵢₙₜ. The measured actual currents I_{D,actual} and I_{Q,actual} are regulated in such a way that the actual torque is equal to the setpoint torque:

M_{actual}=Mₛₑₜₚₒᵢₙₜ (2)

The disadvantage of this procedure is that errors in detecting phase currents I_{U}, I_{V} and I_{W} result in an incorrect actual value I_{D,actual} for the flow-forming current and an incorrect actual value I_{Q,actual} for the torque-forming current. In particular, excessively small values for I_{D,actual} and I_{Q,actual} are critical because in those cases the regulator may set an excessively high torque.

Another disadvantage of the known procedure in which a higher-level regulating structure, for example, a torque regulator, a power regulator, or a d.c. intermediate circuit voltage regulator responds to a torque difference is that the higher-level regulating structure responds with a time delay.

### SUMMARY OF THE INVENTION

In a method for field-oriented regulation of a polyphase machine, it is advantageously achieved that the higher-level regulating structure responds to torque differences considerably more rapidly than in the known methods. Another advantage of the present invention is that existing torque differences are detected using measured variables which are measured in polyphase machines anyway for other purposes. The complexity necessary for detecting torque differences may thus be kept low.

### BRIEF DESCRIPTION OF THE DRAWING

FIG. 1 shows a schematic drawing of a polyphase machine having a corresponding power circuit.

### DETAILED DESCRIPTION

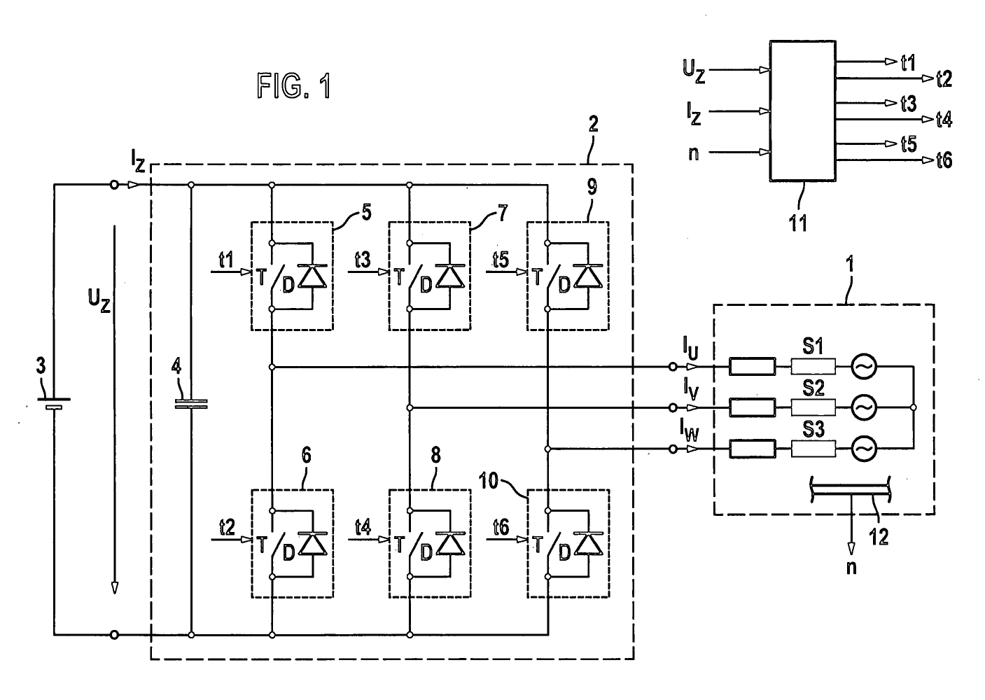

Polyphase machine 1 depicted in FIG. 1 includes three drive phases connected in star configuration which are labeled S1, S2, and S3 in FIG. 1.

Polyphase machine 1 is connected to a pulse-controlled inverter 2, which in turn is connected to a battery 3. Battery 3 is used to supply the electric consumers of a motor vehicle electrical system which are not shown in the figure.

The pulse-controlled inverter is wired in such a way that each of its phases S1, S2, S3 is connected at a connection point between two pulse-controlled inverter elements 5/6, 7/8, 9/10, and the other terminals of each of the pulse-controlled inverter elements are conductively connected to each other. Each pulse-controlled inverter element 5, 6, 7, 8, 9, 10 has a parallel circuit of a switching transistor T and a freewheeling diode D. Each of the switching transistors of the pulse-controlled inverter elements receives a control signal t1, t2, t3, t4, t5, t6. These control signals are provided by a control unit 11.

Furthermore, an intermediate circuit capacitor 4, across which the intermediate circuit voltage U_{Z} drops, is connected between the other terminals of the pulse-controlled inverter elements. The two terminals of intermediate circuit capacitor 4 are connected to the on-board electrical system of the motor vehicle, of which battery 3 is depicted in FIG. 1.

As is furthermore apparent from FIG. 1, intermediate circuit current I_{Z} flows from the on-board electrical system to the pulse-controlled inverter. Furthermore, phase current I_{U} flows in phase S1 of the polyphase machine, phase current I_{V} in phase S2, and phase current I_{W} in phase S3. Polyphase machine 1 has a shaft 12, which rotates at rotational speed n.

During the operation of the polyphase machine, intermediate circuit voltage U_{Z}, intermediate circuit current I_{Z}, and rotational speed n are measured. In the known devices, this is accomplished, for example, in connection with energy management, in which the above parameters are used.

According to the present invention, the following power balance is established and analyzed:

U_{Z}·I_{Z}=M_{actual}·n·2π·η/60. (3)

The following applies:

U_{Z}=intermediate circuit voltage

I_{Z}=intermediate circuit current

M_{actual}=actual torque, and

η=efficiency of the polyphase machine.

By transforming the above equation, the actual torque acting on shaft 12 of the polyphase machine is obtained:

M_{actual}=(U_{Z}·I_{Z}·60)/(2π·n·η). (4)

The actual torque may be subsequently ascertained if first intermediate circuit voltage U_{Z}, intermediate circuit current I_{Z}, and rotational speed n are measured and then the actual torque is calculated according to the above relationship in control unit 11, which receives the measured values. Efficiency η of the polyphase machine is known and is stored in a memory of control unit 11.

In control unit 11, actual torque M_{actual} thus ascertained is compared with the particular setpoint torque present. If actual torque M_{actual} differs from setpoint torque Mₛₑₜₚₒᵢₙₜ by more than a predefined threshold value, control unit 11 acts upon the setpoint variables for the flow-forming current I_{D,setpoint} and torque-forming current I_{Q,setpoint} in such a way that actual torque M_{actual} is brought into agreement with setpoint torque Mₛₑₜₚₒᵢₙₜ. For this purpose, control unit 11 generates control signals t1, t2, t3, t4, t5, t6 for the switching transistors of pulse-controlled elements 5, 6, 7, 8, 9, 10 in such a way that the required phase currents I_{V}, I_{U} and I_{W} are established.

The advantages of this procedure are that the response of the system to the presence of torque differences is considerably faster compared to known methods, and a measurement of phase currents I_{U}, I_{V} and I_{W} for the purpose of calculating the actual torque is no longer needed. Measuring errors occurring during the measurement of the phase currents are thus advantageously prevented from causing incorrect results when the torque is calculated. Another advantage of the present invention is that it is easy to implement because the parameters intermediate circuit voltage, intermediate circuit current, and rotational speed of the polyphase machine needed for calculating the actual torque are measured for other purposes anyway in many cases.

If the difference between the actual torque and the setpoint torque is not successfully counteracted with the aid of a regulation of this type, control unit 11 brings the drive and thus the polyphase machine into a safe state. This is accomplished by control unit 11 bringing switching transistors T of pulse-controlled inverter elements 5, 6, 7, 8, 9, 10 into their blocked state. This results in phase currents I_{U}, I_{V} and I_{W} becoming equal to zero and in no torque being generated any longer.

The subject matter of the present invention may be used, for example, in connection with control units for the electric drive in hybrid vehicles.

1-6. (canceled)

7. A method for field-oriented regulation of a polyphase machine, comprising:
ascertaining an actual torque of the polyphase machine by calculating the actual torque with the aid of a power balance of the polyphase machine;
comparing the ascertained actual torque with a setpoint torque; and
in the event that torque differences occur, modifying setpoint values for a flow-forming current and a torque-forming current to bring the actual torque into agreement with the setpoint torque.

8. The method according to claim 7, wherein the actual torque is calculated with the aid of the following relationship:
M_{actual}=(U_{Z}·I_{Z}·60)/(2π·n·η),
where U_{Z} is an intermediate circuit voltage, I_{Z} is an intermediate circuit current, n is a rotational speed, and η is an efficiency.

9. The method according to claim 7, further comprising, if a difference between the actual torque and the setpoint torque is not successfully counteracted, establishing a safe state of the polyphase machine.

10. A device for field-oriented regulation of a polyphase machine, comprising a control unit for performing the following:
ascertaining an actual torque of the polyphase machine by calculating the actual torque with the aid of a power balance of the polyphase machine,
comparing the ascertained actual torque with a setpoint torque, and
in the event that torque differences occur, modifying setpoint values for a flow-forming current and a torque-forming current to bring the actual torque into agreement with the setpoint torque.

11. The device according to claim 10, wherein the control unit calculates the actual torque of the polyphase machine according to the following relationship:
M_{actual}=(U_{Z}·I_{Z}·60)/(2·π·n·η),
where U_{Z} is an intermediate circuit voltage, I_{Z} is an intermediate circuit current, n is a rotational speed, and η is an efficiency.

12. The device according to claim 10, wherein, if a difference between the actual torque and the setpoint torque is not successfully counteracted, the control unit brings switching transistors of pulse-controlled inverter elements into a blocked state.
